(19) United States
(12) Patent Application Publication
(10) Pub. No.: US 2004/0257802 A1
(43) Pub. Date: Dec. 23, 2004

(54) Support rod for a light source

(76) Inventor: Jacek Helenowski, Stone Park, IL (US)

Correspondence Address: Jacek Helenowski, 4300 W. North Avenue, Stone Park, IL, 60165, US

(21) Appl. No.: 10/464,303

(22) Filed: Jun. 18, 2003

(51) Int. Cl. F21S 4/00; F21V 33/00

(52) U.S. Cl. 362/217; 362/223; 362/253

(57) ABSTRACT

An apparatus includes a light source and a support rod comprising a cavity in which at least a part of the light source is enclosed and at least one opening through which the light source emits light. The support rod supports the light source and provides support for a load, which may include clothing disposed on hangers and/or other items that may be supported by the support rod.

### FIELD OF THE INVENTION

This invention relates to illumination, including but not limited to illumination sources disposed in support rods for clothing and/or other items found in a closet or supported by a rod.

### BACKGROUND OF THE INVENTION

Typical closets include a light fixture attached to the closet's ceiling and a rod that supports clothing on hangers. Often, there is a shelf located between the rod and the light fixture, making it difficult for the light source to provide sufficient illumination on the clothing. Further, the shelf may be located so close to the rod that inserting a light source between the rod and shelf is impractical or dangerous if incandescent lighting is utilized due to potential fire hazard.

Accordingly, there is a need for a method and apparatus for illuminating clothing in a closet, even when a shelf is disposed near the rod.

### BRIEF DESCRIPTION OF THE DRAWINGS

FIG. 1 is a perspective side view of a support rod in accordance with the invention.

FIG. 2 is a perspective bottom view of a support rod in accordance with the invention.

FIG. 3, FIG. 4, and FIG. 5 are bottom views of a support rod in accordance with the invention.

FIG. 6, FIG. 7, and FIG. 8 are end views of a light source disposed in support rod in accordance with the invention.

FIG. 9 is a perspective view of a support rod including ceiling mounts in accordance with the invention.

FIG. 10 is a perspective view of a support rod including wall mounts in accordance with the invention.

FIG. 11 is a perspective view of a support rod incorporated in a portable rack in accordance with the invention.

### DESCRIPTION OF A PREFERRED EMBODIMENT

The following describes an apparatus in which an illumination source is disposed and by which the illumination source is supported. The apparatus includes a support rod that is capable of supporting as load, including clothing and/or other items that may be supported by the support rod, much in the same way that a closet rod supports clothing and/or other items.

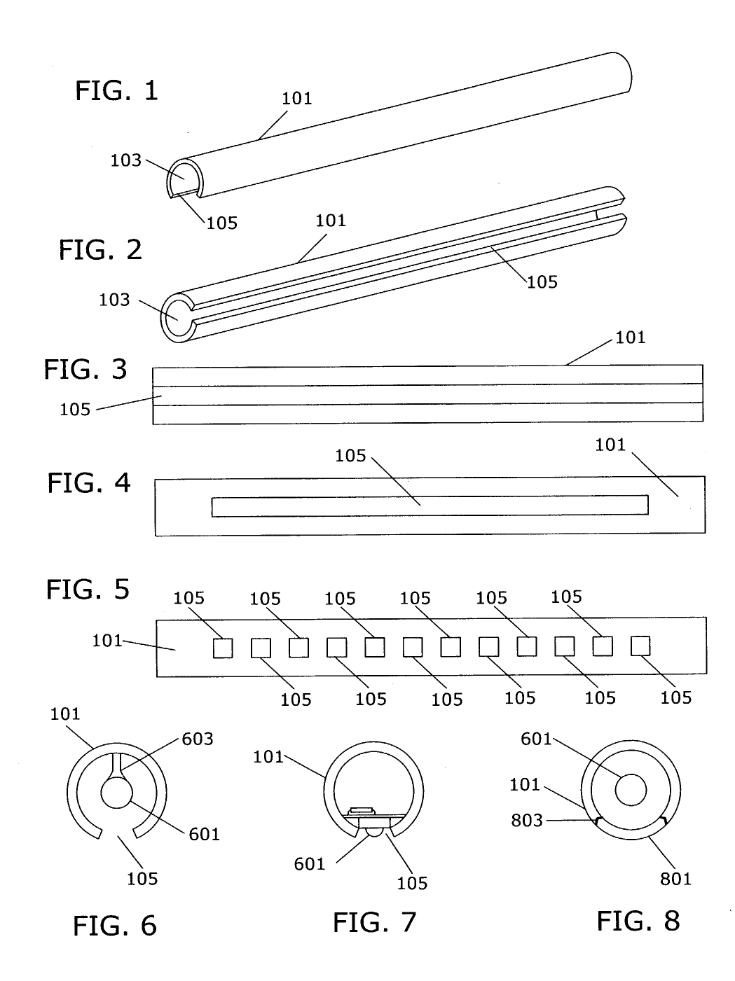

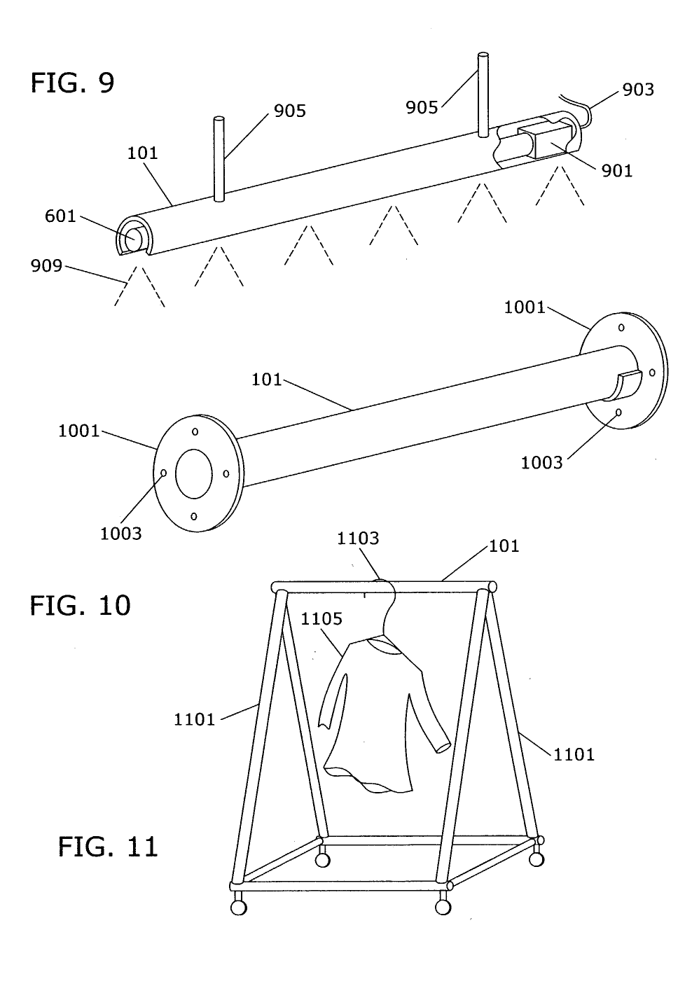

A perspective view of a support rod is shown in FIG. 1. The support rod 101 is shown as an elongated partial annulus or ring. Other shapes, such as oval, rectangular, triangular, and so forth may be utilized. The support rod 101 may be comprised of metal, plastic, glass, or any material structurally capable to support the load to be supported by the rod and may be molded, cast, spun, milled, or otherwise formed. The material is advantageously selected such that potential fire hazards are avoided, especially considering any light source or power source disposed near the support rod 101. The support rod 101 includes a cavity 103 in which a light source, ballast or transformer, or other device may be disposed, such as shown, for example, in FIG. 3, FIG. 4, FIG. 5, and FIG. 9. An opening 105 in the support rod provides an aperture through which the light from the light source is emitted. One embodiment of the opening 105 that extends the entire length of the support rod 101 is shown in FIG. 2.

Bottom views showing various embodiments of the opening(s) of a support rod are shown in FIG. 3, FIG. 4, and FIG. 5. FIG. 3 illustrates the embodiment of FIG. 1 and FIG. 2, where the opening 105 extends the entire length of the support rod 101. FIG. 4 illustrates an embodiment where the opening 105 is a continuous slot that extends partially along the length of the support rod 101. FIG. 5 illustrates an embodiment where a plurality of openings 105 are disposed in the support rod. Although a single light source may be utilized to emit light through the plurality of openings 105 shown in FIG. 5, multiple light sources, such as light emitting diodes (LEDs), incandescent, electroluminescent (EL), fluorescent, compact fluorescent, plasma, neon, cold cathode, and so forth, or any combination thereof, may alternatively be utilized to emit light. For example, a different LED may source light through each opening 105. One or more opening(s) 105 may be utilized. The opening(s) 105 may take on any size, shape(s), or orientation. Although the opening(s) 105 are shown on the bottom of the support rod 101, one or more openings 105 may be provided anywhere along the outer surface of the support rod 101 as long as the rod 101 is able to provide support for the weight, i.e., the load, the support rod 101 is intended to bear. Various opening 105 sizes include narrower openings 105 as shown in FIG. 6 and FIG. 7, and a wider opening as shown in FIG. 8.

End views of a light source 601 disposed in a support rod are shown in FIG. 6, FIG. 7, and FIG. 8. The light source 601 is disposed in the cavity 103 in the support rod 101. The light source 601 may be, for example, incandescent, cold cathode, neon, fluorescent, compact fluorescent, LED, plasma, EL, and so forth, or any combination thereof. The light source 601 may be a single elongated bulb or a plurality of bulbs or LEDs, such as shown in FIG. 7. The light source 601 may provide a one or more different colors, such as may be provided by bulbs of different colors, and/or the light source 601 may provide a variety of different lighting levels, such as may be provided by a dimmer switch. A wall or pull switch may be provided to activate the light source 601. A trigger switch may be provided such that the light source 601 is activated when the closet door is open. Advantageously, the light source 601 provides light for an extended period of time, such as many thousands of hours, to avoid having to change the bulb too often. A source(s) that is energy efficient by nature also provides advantage.

The light source 601 is advantageously fastened to the support rod 101. Examples for fastening include: attaching, e.g., via adhesive, welding and so forth, a bracket inside the support rod 101 and tying the light source 601 to the bracket, such as a cable tie holder, with a flexible line such as a cable tie, wire, and so forth; a compression fit sleeve that holds by friction and may provide shock absorption and may be translucent; and a mounting riser 603 attached to the support rod 101 and a flexible line or clip that attaches the light source 601 to the riser 603. One or more mounting techniques and one or more types of mounting techniques may be utilized. A number of techniques and devices for fastening light sources 601 are known in the industry. Alternatively, the light source 601 may rest on the inner surface of the support rod 101 when the opening 105 is narrower than the outer diameter of the light source 601 or shorter than the length of the light source 601.

The opening(s) 105 may be optionally covered with one or more lens covers 801, such as one or more translucent plastic covers 801. One lens cover 801 may cover a single opening 105 or all the openings. Multiple lens covers 801 may be utilized when multiple openings 105 are present. The lens cover(s) 801 may be any shape, such as flat, angled, or round. As shown in FIG. 8, the lens cover 801 has a partial circular shape whose outer diameter completes a circle with the outer diameter of the support rod 101. Each lens cover 801 may be a compression-fit type cover made of flexible plastic with a flange 803 that fits between the light source 601 and the rod 101 when the lens cover 801 is in place. The lens cover(s) 801 advantageously protect(s) the light source 601 from the hangers 907 or other devices that may damage or harm the light source 601.

A perspective view of a support rod including ceiling mounts is shown in FIG. 9. A power supply 901, such as a ballast or transformer, may also be disposed in the cavity 105 of the support rod 101. Alternatively, the power supply 901 may be remotely located (not shown) from the support rod 101. A ballast or transformer may not be required. Wiring 903 to provide power and/or control signals for the light source may be provided at one end of the support rod 101. Alternatively, the wiring 903 may be routed through ceiling mounts 905 that attach the support rod 101 to the ceiling. The support rod 101, as well as the ceiling mounts 905, are capable of supporting the weight of whatever load hangs from the support rod 101, which load may include, for example, a plurality of hangers and the clothing disposed on the hangers. The ceiling mounts 905 may be comprised of metal or plastic anchors or any structurally sound material capable of supporting the support rod 101 and its load. When the light source 601 is active, the light source 601 emits light 909 that advantageously illuminates at least the clothing 911 disposed on the hangers 907 below the rod 101.

A perspective view of a support rod 101 including wall mounts 1001, as are known in the industry, is shown in FIG. 10. The support rod 101 may be attached to or disposed within mounting brackets 1001 that are secured to two or more walls. The mounting brackets 1001 may be secured with threaded fasteners through holes 1003 in the brackets 1001 to the wall or with other methods or devices. The mounting brackets 1001 may be any type mounting brackets, such as flange mounts (as shown in FIG. 10), metal frames, and so forth sufficient to support the support rod 101 via connection to two or more walls. The support rod 101 may be supported by brackets 1001 at its ends and/or along the length of the rod 101, as known in the industry. The support rod 101 may generally be mounted to one or more walls, the ceiling, and so forth, utilizing techniques known to mount and/or support closet rods.

A perspective view of a support rod incorporated in a rack is shown in FIG. 11. The support rod 101 is incorporated into side supports 1101 of the portable rack. For example, the ends of the support rod 101 may be inserted into mating holes in the side supports 1101. Electrical cabling (not shown) may run through one or more of the supports 1101 to a power source (not shown). The power source may be internal to the supports, such as a transformer or ballast, or external to the supports, such as a battery or electrical cord that may be plugged into a wall. The rack may be portable, including wheels or other devices that render that rack mobile, or stationary. The support rod 101 is capable of supporting the weight of whatever load hangs from the support rod 101, which load may include, for example, a plurality of hangers 1103 and the clothing 1105 disposed on the hangers 1103.

Alternatively, the support rod 101 may be supported by a combination of mounts from above, from any side, and/or from below such that the total load to be supported by the support rod 101 is supported by the combination of mounts 905 and 1001 and/or supports 1101. The supports/mounts may be attached to any combination of ceiling, floor, walls, independent supports, and/or one or more shelves.

The present invention provides a support rod that supports a light source and has one or more openings through which light is emitted. Clothing and/or other items supported by the support rod receive direct illumination from the light source, without obstruction. Even illumination is provided by the light source to minimize shadowing for an even glow.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A support rod comprising:
a cavity in which a light source is disposable; and
at least one opening through which light from the light source is capable of being emitted;
wherein the support rod is capable of at least partially enclosing the light source while supporting the light source and capable of providing support for a load.

2. The support rod of claim 1, wherein the support rod is mountable to one or more walls.

3. The support rod of claim 1, wherein the support rod is supportable from above.

4. The support rod of claim 1, further comprising at least one translucent cover arranged to cover the at least one opening.

5. The support rod of claim 1, wherein at least one of a transformer and a ballast for the light source is disposable in the cavity and supportable by the support rod.

6. The support rod of claim 1, wherein the at least one opening comprises a continuous slot along at least a part of the length of the support rod.

7. The support rod of claim 1, wherein the at least one opening comprises a plurality of openings spaced along a length of the support rod.

8. The support rod of claim 1, wherein the light source is at least one of an incandescent light source, a fluorescent light source, a plasma light source, a cold cathode light source, an electroluminescent light source, and a plurality of light emitting devices.

9. The support rod of claim 1, wherein the load comprises a plurality of hangers and any clothing disposed on the plurality of hangers.

10. A rack incorporating the support rod of claim 1.

11. An apparatus comprising:
a light source;
a support rod comprising a cavity in which at least a part of the light source is enclosed and at least one opening through which the light source emits light;
wherein the support rod supports the light source and provides support for a load.

12. The apparatus of claim 11, further comprising a mounting assembly capable of mounting the support rod to one or more walls.

13. The apparatus of claim 11, further comprising a mounting assembly capable of mounting the support rod to a ceiling.

14. The apparatus of claim 11, further comprising at least one translucent cover arranged to cover the at least one opening.

15. The apparatus of claim 11, wherein at least one of a transformer and a ballast for the light source is disposed in the cavity and supported by the support rod.

16. The apparatus of claim 11, wherein the at least one opening comprises a continuous slot along at least a part of the length of the support rod.

17. The apparatus of claim 11, wherein the at least one opening comprises a plurality of openings spaced along a length of the support rod.

18. The apparatus of claim 11, wherein the light source is at least one of an incandescent light source, a fluorescent light source, a plasma light source, a cold cathode light source, an electroluminescent light source, and a plurality of light emitting devices.

19. The apparatus of claim 11, wherein the load comprises a plurality of hangers and any clothing disposed on the plurality of hangers.

20. The apparatus of claim 11, further comprising a mounting assembly capable of mounting the support rod from below.
